(19) United States
(12) Patent Application Publication
(10) Pub. No.: US 2013/0321342 A1
(43) Pub. Date: Dec. 5, 2013

(54) OPTICAL TOUCH SCREEN EXPANSION METHOD

(71) Applicants: CHUN-YUAN CHENG, Hsinchu (TW); YUEH-HONG SHIH, Hsinchu (TW)

(72) Inventors: CHUN-YUAN CHENG, Hsinchu (TW); YUEH-HONG SHIH, Hsinchu (TW)

(21) Appl. No.: 13/486,256

(22) Filed: Jun. 1, 2012

(51) Int. Cl. G09G 3/36; G06F 3/042

(52) U.S. Cl. 345/175; 345/87

(57) ABSTRACT

An optical touch screen expansion method comprises a primary optical touch module setting process and at least one expanded optical touch module setting process that respectively enable a host to acquire original touch position information according to an identification code thereof and work out information of an absolute position of a touch point via a touch position calibration algorithm, whereby the host can simultaneously control several optical touch modules. Therefore, the present invention enables a single host (i.e., identical software) to control several optical touch modules.

### FIELD OF THE INVENTION

The present invention relates to an optical touch screen technology, particularly to an optical touch screen expansion method.

### BACKGROUND OF THE INVENTION

Refer to FIG. 1 for a conventional interactive projector system. The conventional interactive projector system comprises an optical touch module 1 having an image projecting member 2A and an image capturing member 2B. The image projecting member 2A and the image capturing member 2B may be alternatively arranged separately. The optical touch module 1 is connected with a computer 8. The computer 8 provides instructional information and controls the image projecting member 2A of the optical touch module 1 to present a projected image 4 on a display 3. The image capturing member 2B takes a captured image 5, and then the image projecting member 2A further projects the captured image 5 on the display 3 as a projected image 4. Thus is completed an operation of the interactive projector system. The interactive projector system may apply to teaching. The teacher 6 uses an infrared light spot 7 to make marks or notes on the captured image 5. The image capturing member 2B captures the marks or notes on the captured image 5, and the image projecting member 2A instantly presents the captured image 5 on the display 3 as the projected image 4. Thereby is satisfied the requirement of interactive teaching.

The touch screen has an advantage of instinctive operation and has been popular in speech and teaching. However, with more and more complicated and diversified information, a single touch screen can no more satisfy users now. For example, limited by the screen size, a single touch screen is unlikely to present all the text and illustrations in a large scale speech or instruction occasion.

When the user needs several touch screens to provide notes or information comparison, he has to use an identical number of computers 8 to connect the touch screens or the optical touch modules for display.

As the conventional technology needs several computers 8 to support an identical number of touch screens to form interactive projector systems, it is expensive and hard to popularize.

### SUMMARY OF THE INVENTION

The primary objective of the present invention is to provide an optical touch screen expansion method to enable a single host to simultaneously control several optical touch modules.

To realize the above-mentioned objective, the present invention proposes an optical touch screen expansion method to enable a host to optically control a primary optical touch module and at least one expanded optical touch module, wherein the primary optical touch module and the expanded optical touch module respectively have an identification code (ID). The optical touch screen expansion method comprises a primary optical touch module setting process and at least one expanded optical touch module setting process.

In the primary optical touch module setting process, the host acquires the information of the original touch position of the primary optical touch module according to the ID thereof, and works out the information of the absolute position of the touch point via a touch position calibration algorithm, whereby the host can perform the optical touch control of the primary optical touch module.

In the expanded optical touch module setting process, the host acquires the information of the original touch position of the expanded optical touch module according to the ID thereof, and works out the information of the absolute position of the touch point via a touch position calibration algorithm, whereby the host can perform the optical touch control of the expanded optical touch module.

In brief, the optical touch screen expansion method of the present invention uses a primary optical touch module setting process and at least one expanded optical touch module setting process to enable a single host to control several optical touch modules.

### BRIEF DESCRIPTION OF THE DRAWINGS

FIG. 1 shows a conventional single-mode optical touch system;

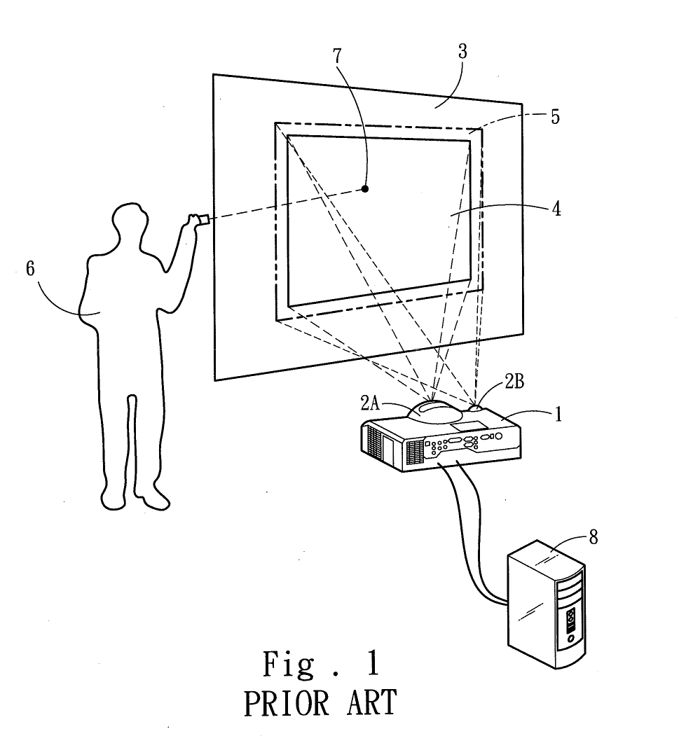

FIG. 2 schematically shows the touch screen mode of an optical touch screen expansion method according to one embodiment of the present invention;

FIG. 3 schematically shows the projector mode of an optical touch screen expansion method according to one embodiment of the present invention;

FIG. 4 shows the flowchart of an optical touch screen expansion method according to one embodiment of the present invention;

FIG. 5 shows the flowchart of a primary optical touch module setting process of an optical touch screen expansion method according to one embodiment of the present invention; and

FIG. 6 shows the flowchart of an expanded optical touch module setting process of an optical touch screen expansion method according to one embodiment of the present invention.

### DETAILED DESCRIPTION OF THE PREFERRED EMBODIMENTS

The technical contents of the present invention are described in detail with embodiments below. However, it should be understood that the embodiments are only to exemplify the present invention but not to limit the scope of the present invention.

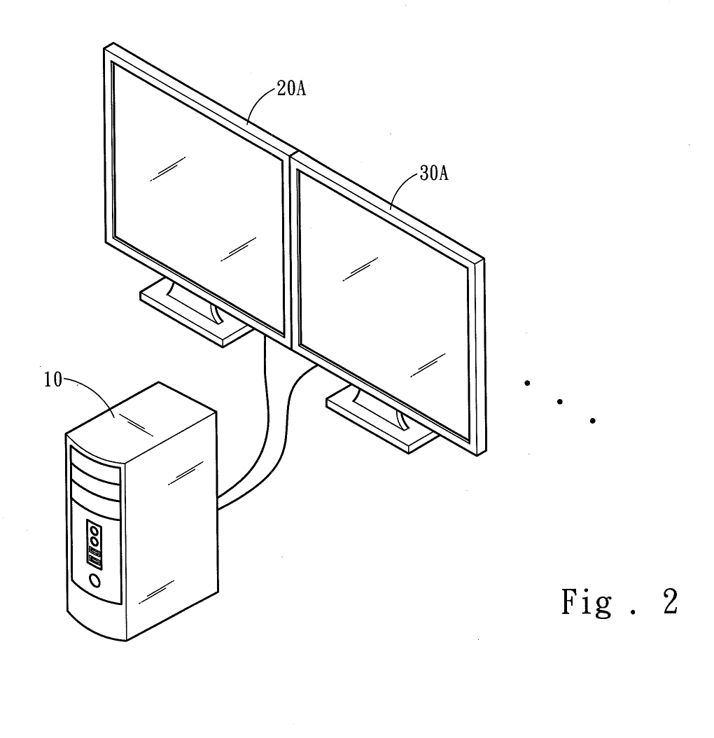

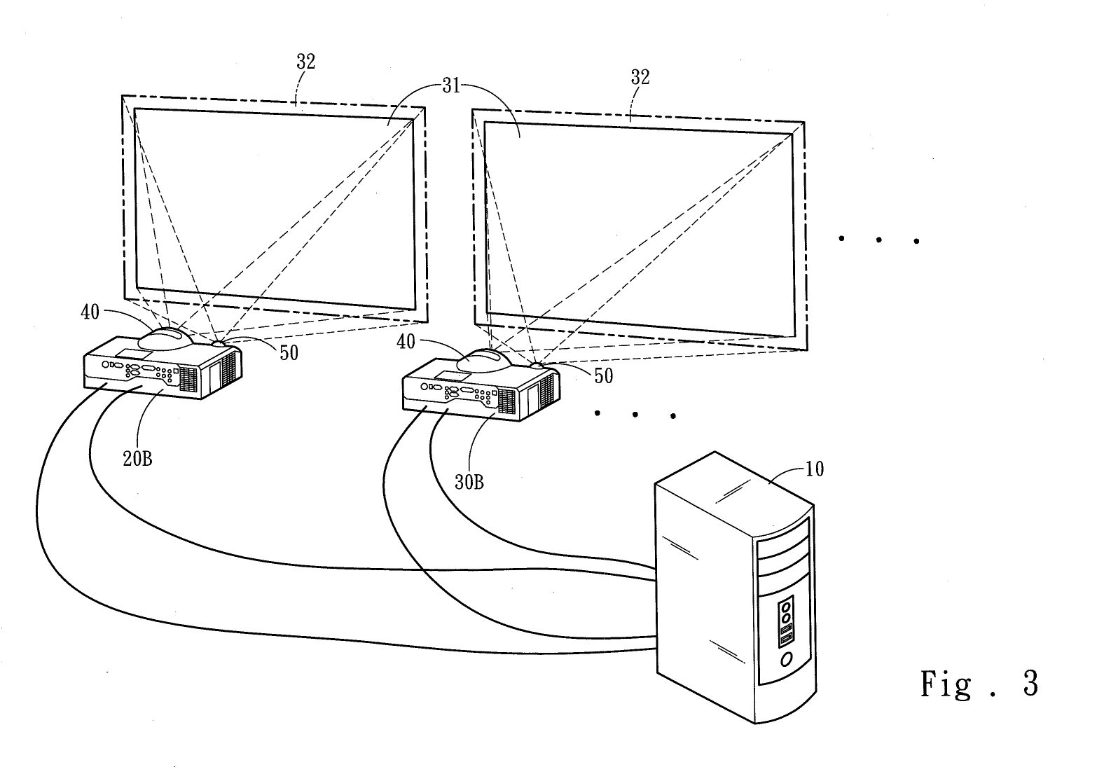

Refer to FIGS. 2-4. The present invention proposes an optical touch screen expansion method, which may operate in two modes—a touch screen mode (shown in FIG. 2) and a projector mode (shown in FIG. 3). In the touch screen mode, the primary optical touch module 20A and at least one expanded optical touch module 30A may be liquid crystal touch screens. In the projector mode, the primary optical touch module 20B and at least one expanded optical touch module 30B respectively have an image projecting member 40 for generating a projected image 31 and an image capturing member 50 for taking a captured image 32.

For the touch screen mode shown in FIG. 2, the primary optical touch module 20A and the expanded optical touch module 30A are arranged closely. However, the primary optical touch module 20A and the expanded optical touch module 30A may also be arranged separately in practical application. For the projector mode shown in FIG. 3, the primary optical touch module 20B and the expanded optical touch module 30B are arranged separately. However, the primary optical touch module 20B and the expanded optical touch module 30B may also be arranged closely in practical application. In the projector mode, the captured image 32 should be larger than the projected image 31.

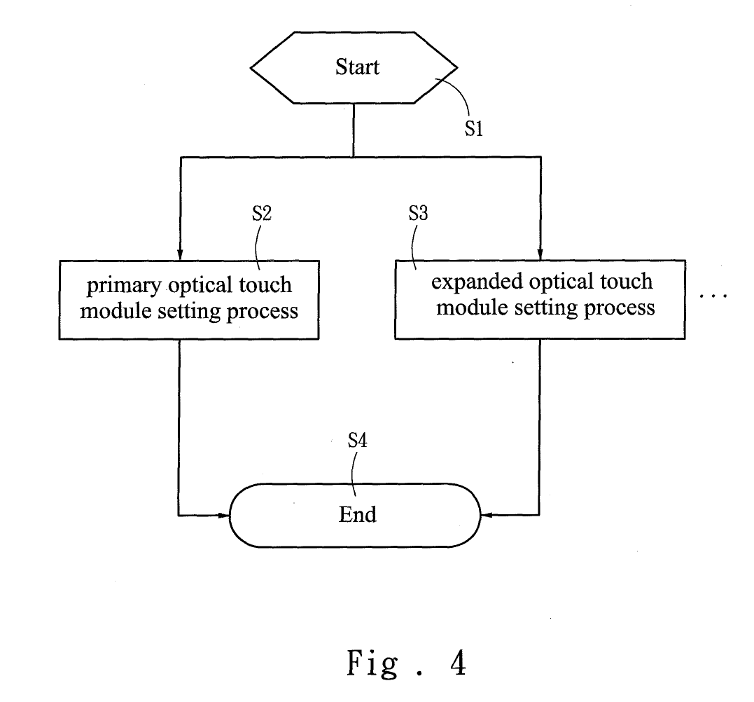

The method of the present invention enables a host 10 to optically control the primary optical touch module 20A/20B and at least one expanded optical touch module 30A/30B. The primary optical touch module 20A/20B and the expanded optical touch modules 30A/30B respectively have an identification code (ID). Refer to FIG. 4. The method of the present invention comprises a primary optical touch module setting process S2 and at least one expanded optical touch module setting process S3 from the start step S1 to the end step S4.

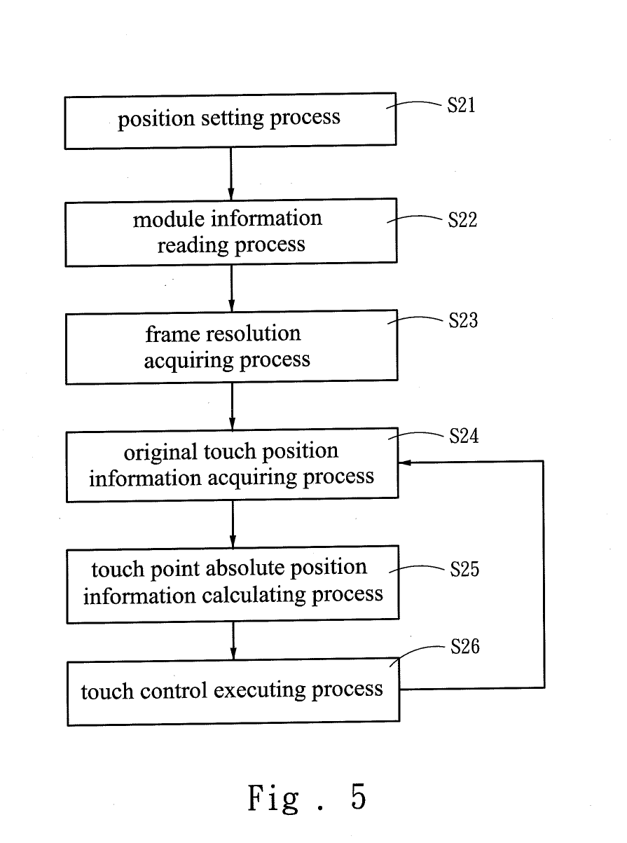

Refer to FIG. 5. The primary optical touch module setting process S2 includes a position setting process S21, a module information reading process S22, a frame resolution acquiring process S23, an original touch position information acquiring process S24, a touch point absolute position information calculating process S25, and a touch control executing process S26. The position setting process S21 enables the host 10 to set the position of the primary optical touch module 20A/20B. The module information reading process S22 is to read the module information of the primary optical touch module 20A/20B according to the identification code (ID) thereof. The frame resolution acquiring process S23 is to acquire the frame resolution of the primary optical touch module 20A/20B. The original touch position information acquiring process S24 is to acquire the original touch position information of the primary optical touch module 20A/20B. The touch point absolute position information calculating process S25 is to work out the information of the absolute position of the touch point of the primary optical touch module 20A/20B via a touch position calibration algorithm. When the user feels that the touch position is incorrect in performing the touch control executing process S26, he may return to the original touch position information acquiring process S24 to run the processes again.

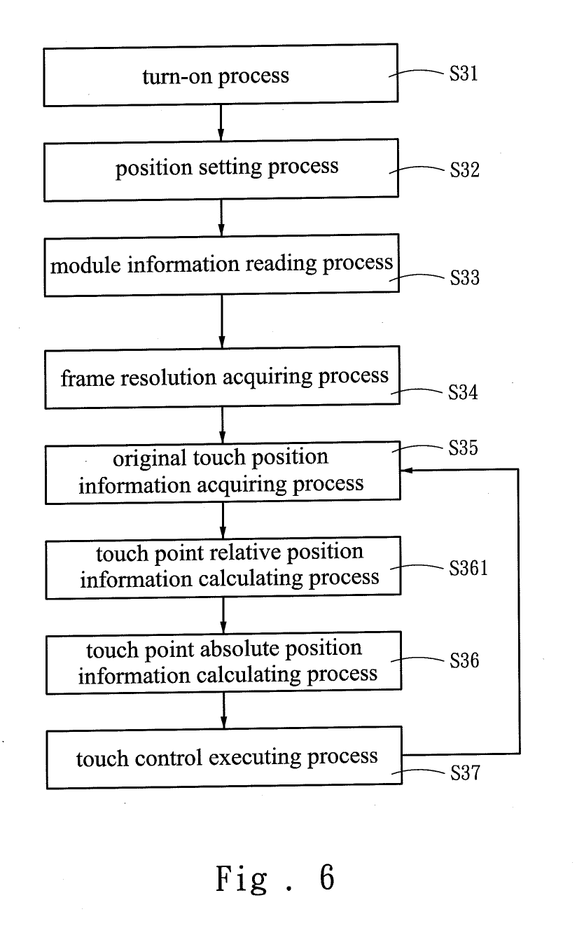

Refer to FIG. 6. The expanded optical touch module setting process S3 includes a turn-on process S31, a position setting process S32, a module information reading process S33, a frame resolution acquiring process S34, an original touch position information acquiring process S35, a touch point absolute position information calculating process S36, and a touch control executing process S37. The turn-on process S31 turns on at least one expanded optical touch module 30A/30B. The position setting process S32 enables the host 10 to set the position of the expanded optical touch module 30A/30B. The module information reading process S33 is to read the module information of the expanded optical touch module 30A/30B according to the identification code (ID) thereof. The frame resolution acquiring process S34 is to acquire the frame resolution of the expanded optical touch module 30A/30B. The original touch position information acquiring process S35 is to acquire the original touch position information of the expanded optical touch module 30A/30B. The touch point absolute position information calculating process S36 is to work out the information of the absolute position of the touch point of the expanded optical touch module 30A/30B via a touch position calibration algorithm. When the user feels that the touch position is incorrect in performing the touch control executing process S37, he may return to the original touch position information acquiring process S35 to run the processes again.

Before the touch point absolute position information calculating process S36 for the expanded optical touch module 30A/30B, a touch point relative position information calculating process S361 is undertaken to work out relative position information of a touch point of the expanded optical touch module 30A/30B. Then, the relative position information and the absolute position information of the touch point of the expanded optical touch module 30A/30B are superimposed. The absolute position is determined according to the resolution of the primary optical touch module 20A/20B and expanded optical touch module 30A/30B, which have been set by the host. Suppose that the relative position information of the touch point is (A, B) and that the resolution of the set optical touch module is (1024, 768). Thus, the absolute position information of the touch point may be (0, 768) or (1024, 0). Then, the absolute position information of the touch point of the expanded optical touch module 30A/30B is worked out to be (A, B+768) or (A+1024, B). Thereby, the host 10 can perform touch control to the absolute position information of the touch point. Hence, the host 10 can simultaneously control the primary optical touch module 20A/20B and the expanded optical touch module 30A/30B.

In conclusion, the present invention uses a primary optical touch module setting process and at least one expanded optical touch module setting process to enable a host to control several optical touch modules. Supported by hardware, the user can select several optical touch modules arbitrarily and perform optical touch control of them. Via obtaining the resolutions of the screens, the present invention can further provide the convenience to simultaneously control optical touch modules of different resolutions.

Therefore, the present invention can satisfy the requirement of simultaneously controlling several optical touch modules in a computer-aided instruction or other computer applications.

What is claimed is:

1. An optical touch screen expansion method, which enables a host to optically control a primary optical touch module and at least one expanded optical touch module that respectively have an identification code, and which comprises steps:
a primary optical touch module setting process enabling the host to acquire information of an original touch position of the primary optical touch module according to the identification code thereof and work out information of an absolute position of a touch point via a touch position calibration algorithm, whereby the host performs optical touch control of the primary optical touch module; and
at least one expanded optical touch module setting process enabling the host to acquire information of an original touch position of the at least one expanded optical touch module according to the identification code thereof and work out information of an absolute position of a touch point via the touch position calibration algorithm, whereby the host performs optical touch control of the at least one expanded optical touch module.

2. The optical touch screen expansion method according to claim 1, wherein the primary optical touch module setting process includes a position setting process, a module information reading process, an original touch position information acquiring process, and a touch point absolute position information calculating process, and wherein the position setting process enables the host to set a position of the primary optical touch module, and wherein the module information reading process is to read module information of the primary optical touch module according to the identification code thereof, and wherein the original touch position information acquiring process is to acquire original touch position information of the primary optical touch module, and wherein the touch point absolute position information calculating process is to work out the information of the absolute position of the touch point of the primary optical touch module via the touch position calibration algorithm.

3. The optical touch screen expansion method according to claim 2, wherein the primary optical touch module setting process further includes a frame resolution acquiring process to acquire a frame resolution of the primary optical touch module.

4. The optical touch screen expansion method according to claim 1, wherein the at least one expanded optical touch module setting process includes a turn-on process, a position setting process, a module information reading process, an original touch position information acquiring process, and a touch point absolute position information calculating process, and wherein the turn-on process is to turn on the at least one expanded optical touch module, and wherein the position setting process enables the host to set a position of the expanded optical touch module, and wherein the module information reading process is to read module information of the expanded optical touch module according to the identification code of the expanded optical touch module, and wherein the original touch position information acquiring process is to acquire original touch position information of the expanded optical touch module, and wherein the touch point absolute position information calculating process is to work out the information of the absolute position of the touch point of the expanded optical touch module via the touch position calibration algorithm.

5. The optical touch screen expansion method according to claim 4, wherein the at least one expanded optical touch module setting process further includes a frame resolution acquiring process to acquire a frame resolution of the expanded optical touch module.

6. The optical touch screen expansion method according to claim 4, wherein before the touch point absolute position information calculating process, a touch point relative position information calculating process is undertaken to work out relative position information of the touch point of the expanded optical touch module, whereafter absolute position information of the touch point of the expanded optical touch module is worked out according to the original touch position information of the expanded optical touch module.

7. The optical touch screen expansion method according to claim 1, wherein the primary optical touch module and the at least one expanded optical touch module are liquid crystal touch screens.

8. The optical touch screen expansion method according to claim 1, wherein the primary optical touch module and the at least one expanded optical touch module respectively have an image projecting member and an image capturing member.
